(19) United States
(12) Patent Application Publication
(10) Pub. No.: US 2024/0067016 A1
(43) Pub. Date: Feb. 29, 2024

(54) CABLE MANAGEMENT APPARATUS OF AN ELECTRIC VEHICLE CHARGING STATION

(71) Applicant: ChargePoint, Inc., Campbell, CA (US)

(72) Inventors: Stan C. Reyes, San Jose, CA (US); William Rich, Emerald Hills, CA (US); John Hsudan Yu, Fremont, CA (US); Kevin Fetterman, San Jose, CA (US); Aaron Dayton Little, Campbell, CA (US); Stephen Eric Sidle, Morgan Hill, CA (US); Pasquale Romano, Los Gatos, CA (US)

(21) Appl. No.: 18/459,055

(22) Filed: Aug. 31, 2023

Related U.S. Application Data
(60) Provisional application No. 63/402,811, filed on Aug. 31, 2022.

(51) Int. Cl. B60L 53/31; B60L 53/18

(52) U.S. Cl. CPC B60L 53/31; B60L 53/18

(57) ABSTRACT

A cable management apparatus of an electric vehicle charging station for managing an electric vehicle charging cable is described. The cable management apparatus comprises a housing and a swing arm. The housing houses a hub connected to a swing arm housing to allow the swing arm housing to rotate about the hub from a starting position to an ending position. The housing further houses a damper, where a first end is attached to the housing of the cable management apparatus and a second end is attached to the swing arm housing to manage retraction of the swing arm housing. The housing further houses a first rotation stop element to prevent the swing arm housing from rotating beyond the ending position. The cable management apparatus further comprises the swing arm housing connected to the housing of the cable management apparatus by the hub and the second end of the damper.

### CROSS-REFERENCE TO RELATED APPLICATIONS

This application claims the benefit of U.S. Provisional Application No. 63/402,811, filed Aug. 31, 2022, which is hereby incorporated by reference.

### FIELD

Embodiments of the invention relate to the field of electric vehicle charging; and more specifically, to a cable management apparatus for managing an electric vehicle charging cable.

### BACKGROUND

Electric vehicle charging station (sometimes referred to as electric vehicle supply equipment (EVSE)) include charging cables with connectors that supply electrical power to electric vehicles. As the number of electric vehicles increases, the demand for electric vehicle charging stations increases. These electric vehicle charging stations can experience significant wear and tear from use, including damage to charging cables and the electric vehicle charging stations themselves.

### SUMMARY

An aspect includes a cable management apparatus of an electric vehicle charging station for managing an electric vehicle charging cable. The cable management apparatus includes a housing that houses a hub connected to a swing arm housing to allow the swing arm housing to rotate about the hub from a starting position to an ending position. The cable management apparatus also includes a damper. A first end of the damper is attached to the housing of the cable management apparatus and a second end of the damper is attached to the swing arm housing to manage retraction of the swing arm housing from a location up to the ending position back to the starting position. The cable management apparatus also includes a first rotation stop element to obstruct, or otherwise prevent, the swing arm housing from rotating beyond the ending position. The cable management apparatus further includes the swing arm housing connected to the housing of the cable management apparatus by the hub and the second end of the damper.

An aspect includes a rotation enabling element within the swing arm housing, where rotation of the rotation enabling element can be obstructed by a second rotation stop element molded or attached to the swing arm housing. The swing arm housing can further include a shaft member latched to the rotation enabling element. A cable tether can latch to the shaft member to suspend an electric vehicle charging cable above the ground.

### BRIEF DESCRIPTION OF THE DRAWINGS

The invention may best be understood by referring to the following description and accompanying drawings that are used to illustrate embodiments of the invention. In the drawings:

FIG. 1 illustrates a front view of an exemplary electric vehicle charging station according to an embodiment.

FIG. 2 illustrates a side view of an exemplary electric vehicle charging station shown in FIG. 1 according to an embodiment.

FIG. 3 illustrates a three-quarters view of an exemplary electric vehicle charging station shown in FIG. 1 according to an embodiment.

FIG. 4 illustrates an exemplary electric vehicle charging station cable management structure according to an embodiment.

FIG. 5 illustrates a three-quarters view of an exemplary electric vehicle charging station cable management structure shown in FIG. 4 according to an embodiment.

FIG. 6 illustrates multiple views of an exemplary electric vehicle charging station cable management structure according to an embodiment.

FIG. 7 illustrates an interior view of the housing of an exemplary electric vehicle charging station cable management structure according to an embodiment.

FIG. 8 illustrates a view of an exemplary electric vehicle charging station cable management structure shown in FIG. 7 with an extended arm according to an embodiment.

FIG. 9 is a close-up view of a hub connecting an arm to an electric vehicle charging station cable management structure according to an embodiment.

FIG. 10 is a close-up view of interior components connecting an arm to an electric vehicle charging station cable management structure according to an embodiment.

FIG. 11 is a close-up view of interior components of an arm of an electric vehicle charging station cable management structure according to an embodiment.

FIG. 12 is an overhead view of a rotation enabling element engaging with a rotation stop element according to an embodiment.

FIG. 13 is a detailed view of an axle hat and a shaft member shown in FIG. 11 according to an embodiment.

### DESCRIPTION OF EMBODIMENTS

A cable management apparatus for managing an electric vehicle charging cable of an electric vehicle charging station is described. The cable management apparatus includes swing arms that can suspend electric vehicle charging cables above the ground. The swings arms can be configured to rotate away from the electric vehicle charging station to extend the reach of an electric vehicle charging cable connector during an electric vehicle charging session. Suspending the electric vehicle charging cable prevents the electric vehicle charging cable from resting on the ground and shifts some of the weight of the electric vehicle charging cable, allowing for easier movement and maneuvering of the electric vehicle charging cable connector by a user. In an embodiment, dampers are disposed within the cable management apparatus, connecting a housing of the cable management apparatus to the housing of the swing arm. When the swing arm is extended from a starting position and then released, a damper in the swing arm dampens the retraction of the swing arm back to the starting position.

Many existing solutions use a spring retraction or counterweight system. For these systems, the spring/counterweight force must exceed the electric vehicle charging cable weight to pull the electric vehicle charging cable back into the starting position when not in use. The spring/counterweight thus requires the user to pull with a force significantly greater than the weight of the electric vehicle charging cable to extend the electric vehicle charging cable, which can exceed 50 pounds of force.

Embodiments of the invention provide technical advantages, in addition to addressing the deficiencies of previous solutions. For example, embodiments described herein include an arm (e.g., a swing arm) that is designed to rotate the electric vehicle charging cable weight so the force to extend the electric vehicle charging cable reach does not approach the electric vehicle charging cable weight. Suspending the electric vehicle charging cable from the arms prevents the electric vehicle charging cable from resting on the ground and also shifts some of the weight of the electric vehicle charging cable, allowing for easier movement and maneuvering of the electric vehicle charging cable connector by a user.

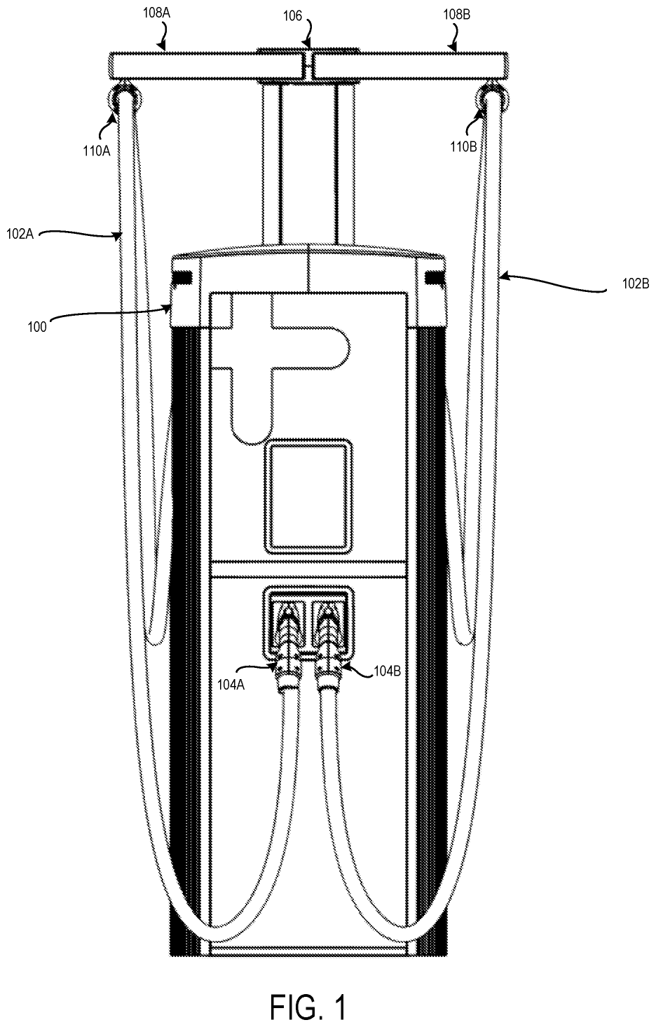

FIG. 1 illustrates a front view of an exemplary electric vehicle charging station according to an embodiment. The electric vehicle charging station 100 includes electric vehicle charging cables 102A and 102B connected to charging connectors 104A and 104B, for supplying electrical power to an electric vehicle. As illustrated in FIG. 1, an electric vehicle charging station 100 includes an electric vehicle charging station cable management structure 106. The electric vehicle charging station cable management structure 106 includes arms 108A and 108B from which cable tethers 110A and 110B can be suspended. In an embodiment, the arms 108A and 108B are swing arms that further allow the electric vehicle charging cable to extend a greater distance from the electric vehicle charging station towards an electric vehicle. While FIG. 1 depicts the electric vehicle charging station cable management structure 106 with two arms, in some embodiments, the electric vehicle charging station cable management structure 106 can include one arm or more than two arms.

As shown in FIG. 1, electric vehicle charging cables 102A and 102B are passed through an opening of the cable tethers 110A and 110B to suspend the electric vehicle charging cable and prevent the electric vehicle charging cables 102A and 102B from resting on the ground.

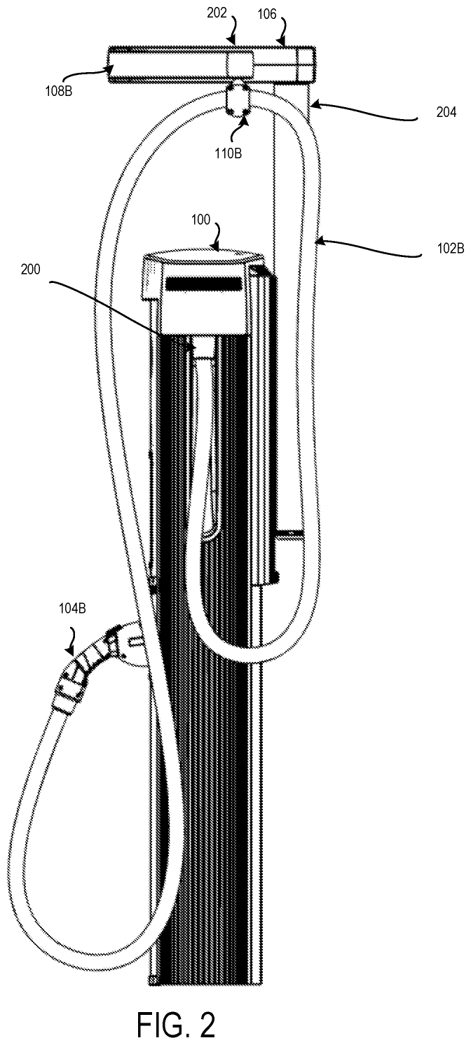

FIG. 2 illustrates a side view of an exemplary electric vehicle charging station shown in FIG. 1 according to an embodiment. As illustrated in FIG. 2, the electric vehicle charging station cable management structure 106 includes a housing 202 and a mast section 204. In some embodiments, the mast section 204 is attached to the electric vehicle charging station 100. In other embodiments, the mast section 204 can be integrated into the electric vehicle charging station 100. The mast section 204 can suspend the housing 202 of the electric vehicle charging station cable management structure 106 above the electric vehicle charging station 100. In an embodiment, the height of the housing 202 above the electric vehicle charging station 100 can be extended upwards or downwards depending on a height clearance where the electric vehicle charging station 100 is installed.

As illustrated in FIG. 2, arm 108B is attached to the electric vehicle charging station cable management structure 106. The electric vehicle charging cable 102B is attached to the electric vehicle charging station 100 at a connection point 200 at one end and to charging connector 104B at another end. The electric vehicle charging cable 102B passes through an opening of the cable tether 110B suspended from arm 108B.

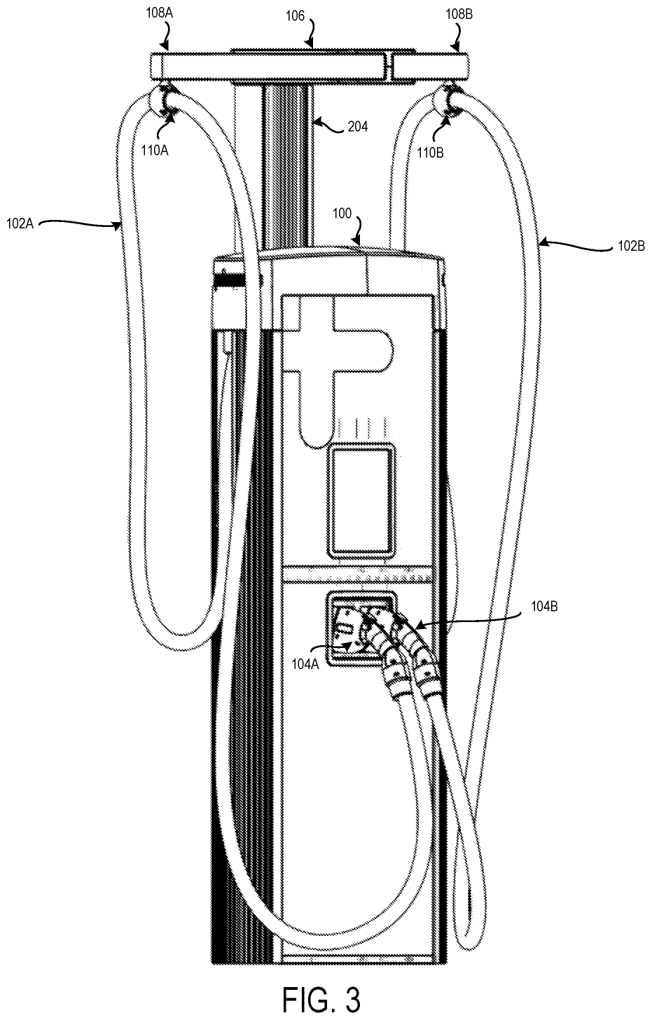

FIG. 3 illustrates a three-quarters view of an exemplary electric vehicle charging station shown in FIG. 1 according to an embodiment.

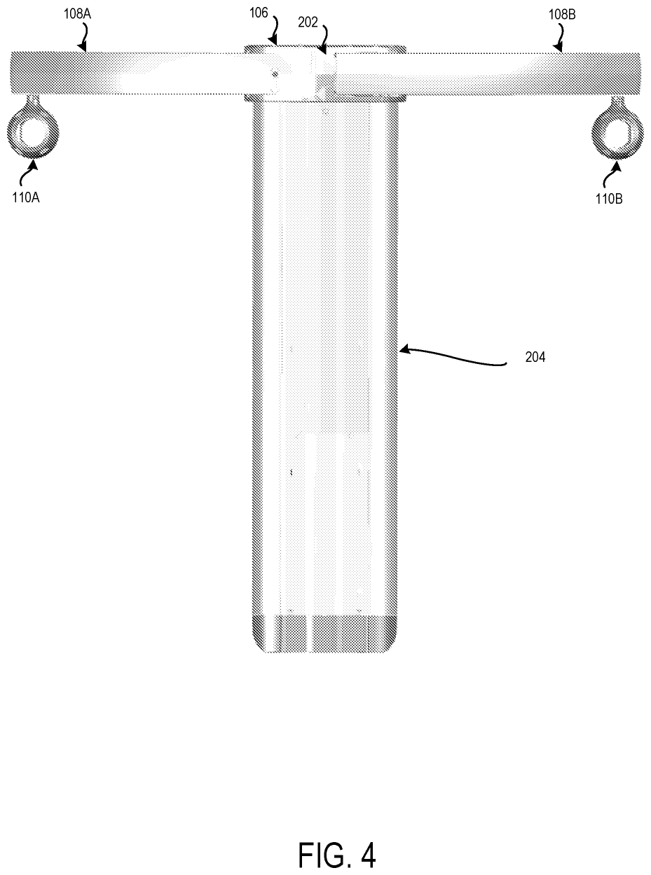

FIG. 4 illustrates an exemplary electric vehicle charging station cable management structure according to an embodiment. FIG. 4 shows an electric vehicle charging station cable management structure 106 with arms 108A and 108B attached. In an embodiment, the electric vehicle charging station cable management structure 106 can be a separate housing that can be attached to an electric vehicle charging station (e.g., by attaching the mast section 204 to the electric vehicle charging station). In other embodiments, the electric vehicle charging station cable management structure 106 can be integrated into an electric vehicle charging station. Cable tethers 110A and 110B can be attached to the arms 108A and 108B, respectively, to allow the cable tethers 110A and 110B to be suspended.

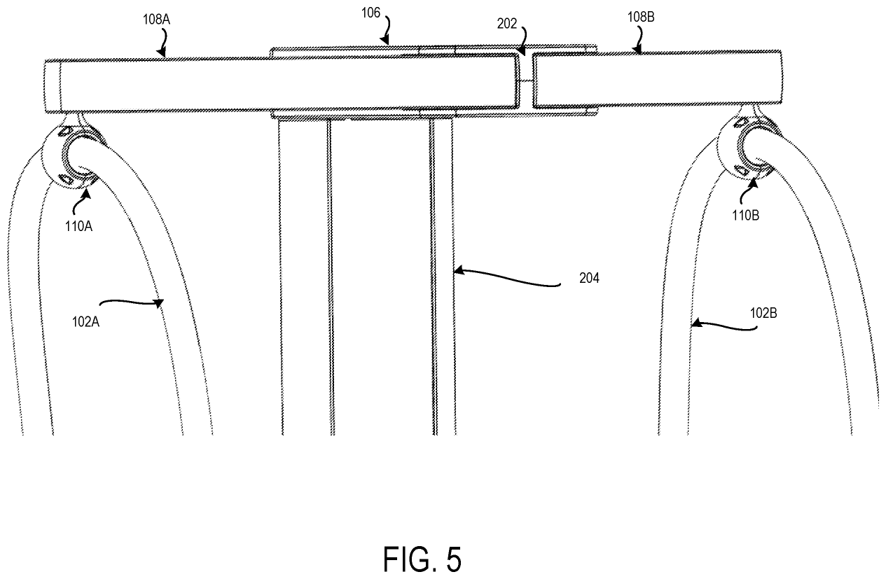

FIG. 5 illustrates a three-quarters view of an exemplary electric vehicle charging station cable management structure shown in FIG. 4 according to an embodiment. FIG. 5 depicts a close-up view of the arms 108A and 108B of the electric vehicle charging station cable management structure 106. In the embodiment shown in FIG. 5, electric vehicle charging cables 102A and 102B are gripped within openings of cable tethers 110A and 110B suspended from the arms 108A and 108B. In other embodiments, different types of devices, including different configurations of cable tethers, can be attached or suspended from the arms 108A and 108B.

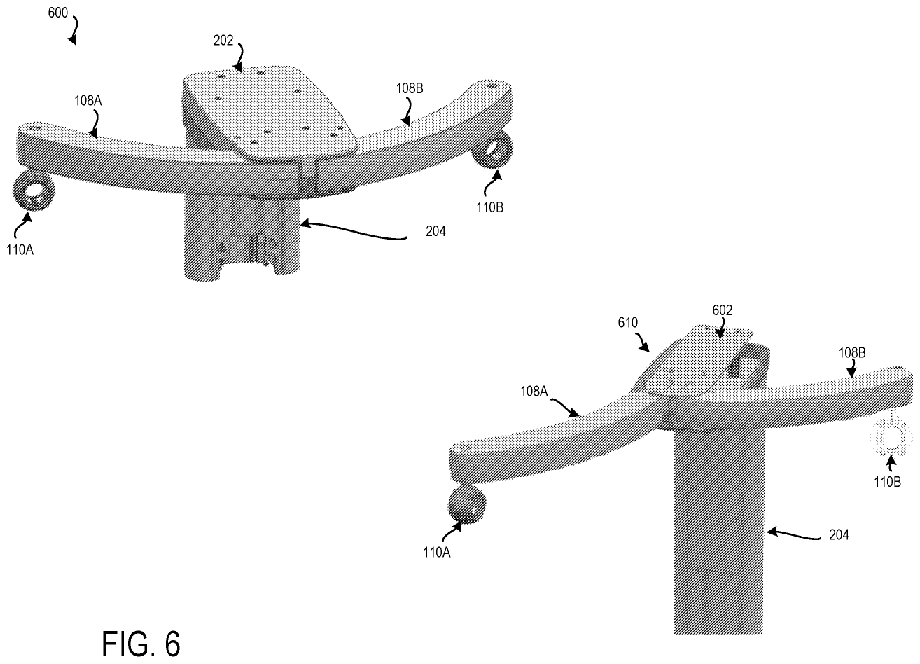

FIG. 6 illustrates views of an exemplary electric vehicle charging station cable management structure according to an embodiment. A first view 600 shows an electric vehicle charging station cable management structure with both arms 108A and 108B in starting positions. A second view 610 shows an electric vehicle charging station cable management structure with both arm 108A in an extended position and arm 108B in a starting position. As illustrated in FIG. 6, the second view 610 further illustrates the interior of the housing 202 after a top panel of the housing 202 has been removed revealing an interior housing 602.

When arm 108A is rotated outward from the starting position, the reach of an electric vehicle charging cable gripped by cable tether 110A can be extended a greater distance from the electric vehicle charging station towards an electric vehicle. When a charging process is completed, the arm 108A can be rotated, or retracted, back to the starting position. As illustrated in FIG. 6, cable tethers 110A and 110B are suspended from arms 108A and 108, respectively, and can be used to suspend an electric vehicle charging cable to prevent the electric vehicle charging cable from resting on the ground.

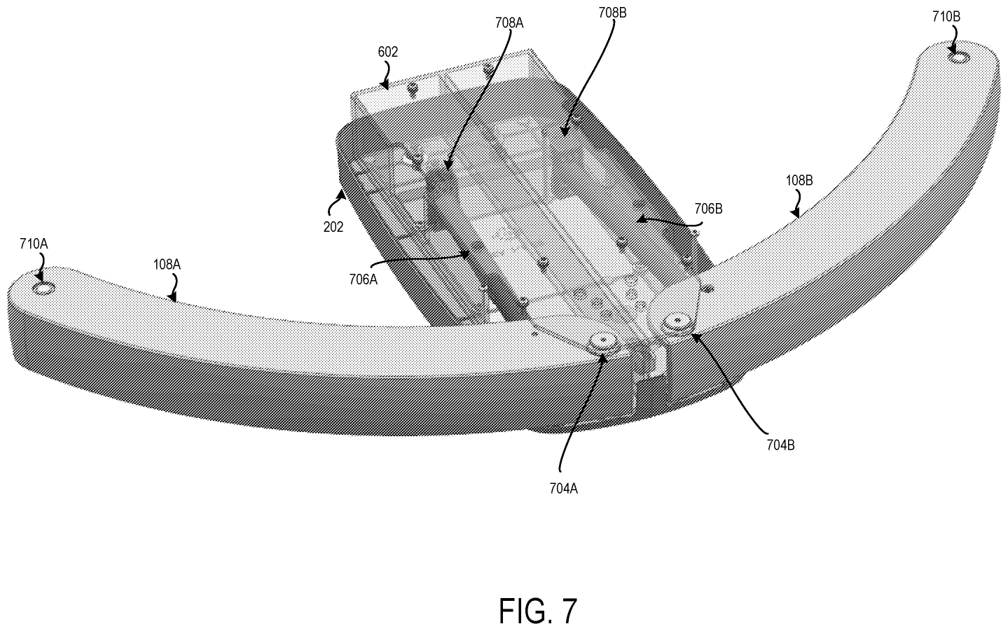

FIG. 7 illustrates an interior view of the housing of an exemplary electric vehicle charging station cable management structure according to an embodiment. As illustrated in FIG. 7, a top panel of housing 202 has been removed revealing the interior of the housing 202. In an embodiment, the interior of the housing 202 includes the interior housing 602. In FIG. 7, arm 108A is attached, or connected, to the housing 202, and the interior housing 602 of the housing 202, by a hub 704A. Similarly, arm 108B is attached, or connected, to the housing 202, and the interior housing 602 of the housing 202, by a hub 704B.

In embodiments where arms 108A and 108B are swing arms, hubs 704A and 704B are rotating hubs that allow arms 108A and 108B to extend away from and retract back towards the housing 202. In an embodiment, the extension and retraction of arms 108A and 108B can be managed by dampers 706A and 706B, respectively. In an embodiment, the dampers 706A and 706B are traction dampers. As illustrated in FIG. 7, first ends of the dampers 706A and 706B are inserted into mounting elements 708A and 708B, respectively. The mounting elements 708A and 708B are then connected to the housing 202 to secure the first ends of the dampers 706A and 706B.

In an embodiment, housed in arm 108A is a rotation enabling element 710A. The rotation enabling element 710A can include a shaft member that extends outside the arm 108A to allow the attachment of a cable tether. In an embodiment, the rotation enabling element 710A is located towards an end opposite to the end attached to the housing by the hub 704A. In other embodiments, the rotation enabling element 710A can be located at other locations along the arm 108A. Similarly, arm 108B can include a rotation enabling element 710B that can be positioned similarly along arm 108B.

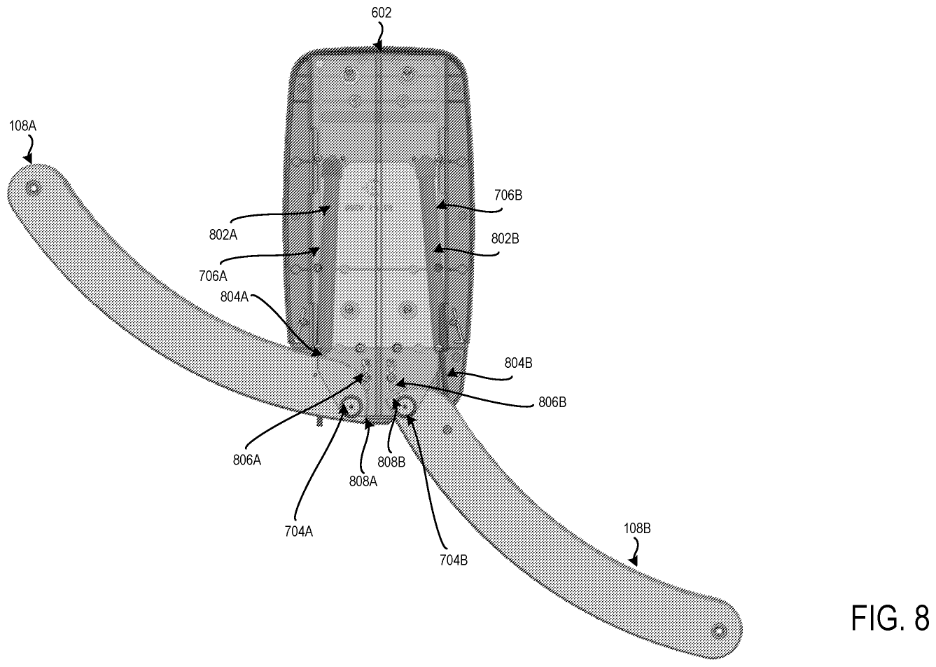

FIG. 8 illustrates a view of an exemplary electric vehicle charging station cable management structure shown in FIG. 7 with an extended arm according to an embodiment. FIG. 8 illustrates additional details for dampers 706A and 706B. For example, damper 706A includes, at least, a damper housing 802A and a piston rod 804A. Similarly, damper 706B includes, at least, a damper housing 802B and a piston rod 804B. As shown in FIG. 8, arm 108B has been extended away from a housing 202 of the electric vehicle charging station cable management structure. In an embodiment, as the arm 108B is extended or rotated from a starting position to a position illustrated in FIG. 8, the piston rod 804B of the damper 706B is withdrawn from the damper housing 802B. In an embodiment, releasing the arm 108B from a location other than the starting location, including from the position illustrated in FIG. 8, causes the damper 706B to dampen the retraction of the arm 108B back to the starting position.

The housing 202 of the electric vehicle charging station cable management structure further includes rotation stop elements 806A and 806B. The rotation stop elements 806A and 806B are configured to prevent arms 108A and 108B from rotating beyond an ending position. In an embodiment, rotation stop elements 806A and 806B are rigid structures that, once contacted, can impede further rotation. For example, when arm 108B is rotated away from the housing 202 of the electric vehicle charging station cable management structure, an ending position of the rotation is reached when an edge portion 808B of the arm 108B contacts rotation stop element 806B. Similarly, the rotation of arm 108A can impeded when an edge portion 808A contacts the rotation stop element 806A as arm 108A is rotated away from the housing 202 of the electric vehicle charging station cable management structure.

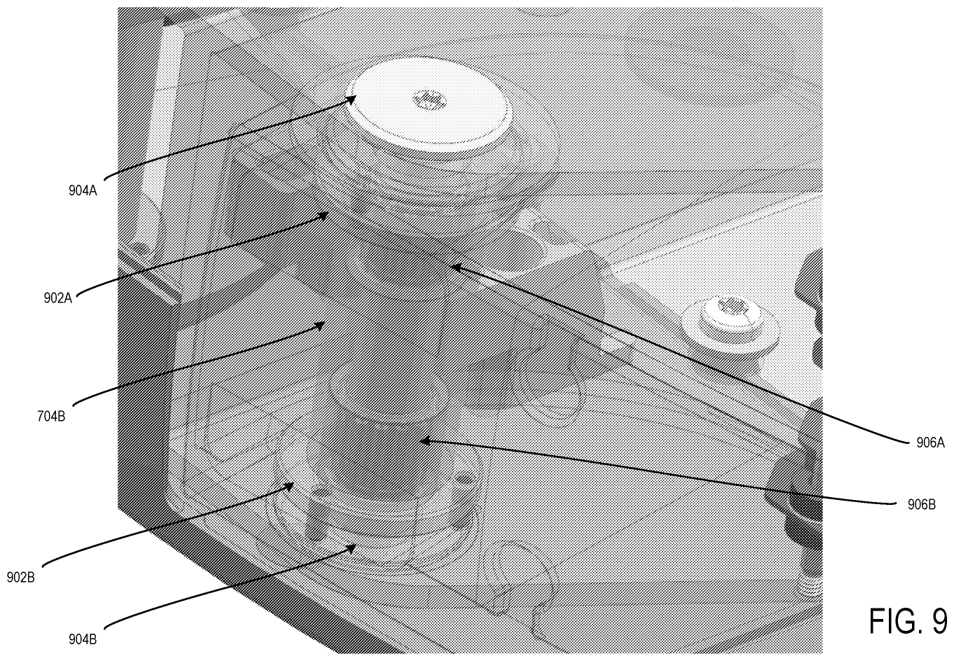

FIG. 9 is a close-up view of a hub connecting an arm to an electric vehicle charging station cable management structure according to an embodiment. FIG. 9 illustrates additional details of hub 704B from FIG. 7. Hub 704B includes a first attaching end 902A that is attached to a top hub cap 904A at a top of a swing arm housing of arm 108A and a second attaching end 902B that that is attached to a bottom hub cap 904B at a rotation stop element 806B. The hub 704B can be further attached to an interior housing (e.g., interior housing 602 of FIG. 6). In an embodiment, the hub 704B include needle roller bearings 906A and 906B that facilitate the rotational movement of the hub 704B.

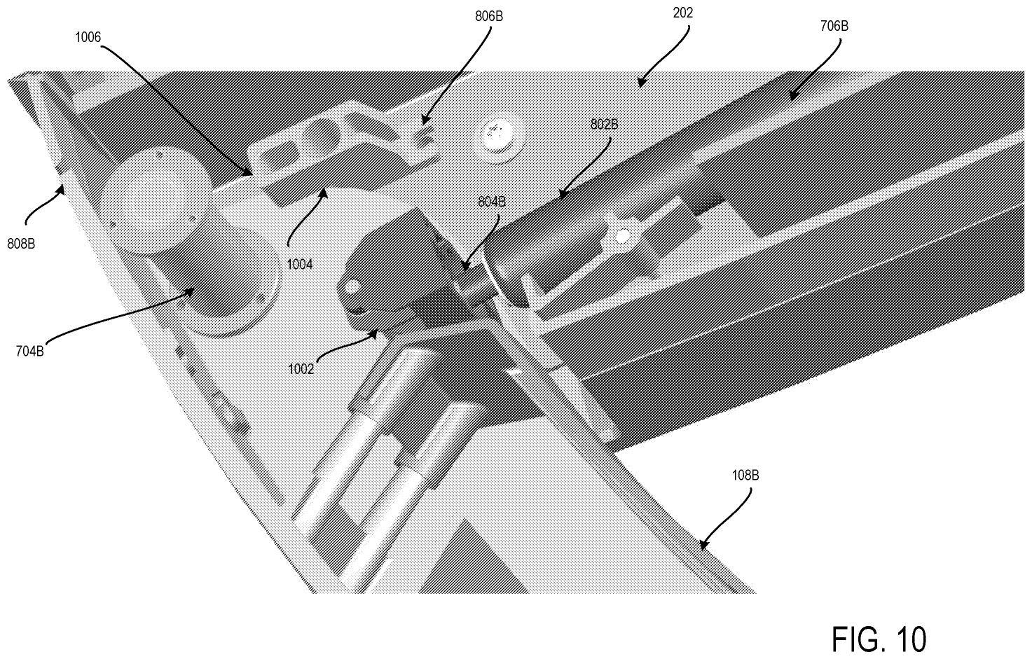

FIG. 10 is a close-up view of interior components connecting an arm to an electric vehicle charging station cable management structure according to an embodiment. As shown in FIG. 10, mounting element 1002 mounts an end of a damper 706B to an arm 108B. The mounting element 1002 can be attached to a piston rod 804B of damper 706B, while the damper housing 802B can be attached to the housing 202 (e.g., as shown in FIG. 7). As arm 108B is rotated away from the electric vehicle charging station cable management structure the piston rod 804B of damper 706B is withdrawn from the damper housing 802B.

FIG. 10 further illustrates another view of rotation stop element 806B, which is configured to stop the arm 108B from rotating beyond an ending position. The rotation stop element 806B can be affixed, attached, or otherwise connected, to the housing 202 (e.g., user screws or other types of fasteners). The rotation stop element 806B includes a cutout portion 1004 that allows rotation stop element 806B to pass under the rotation stop element 806B until the edge portion 808B of the arm 108B contacts an edge 1006, or side, of rotation stop element 806B. The rotation stop element 806B shown in FIG. 10 is an example, and the configuration and shape of the rotation stop element 806B can vary.

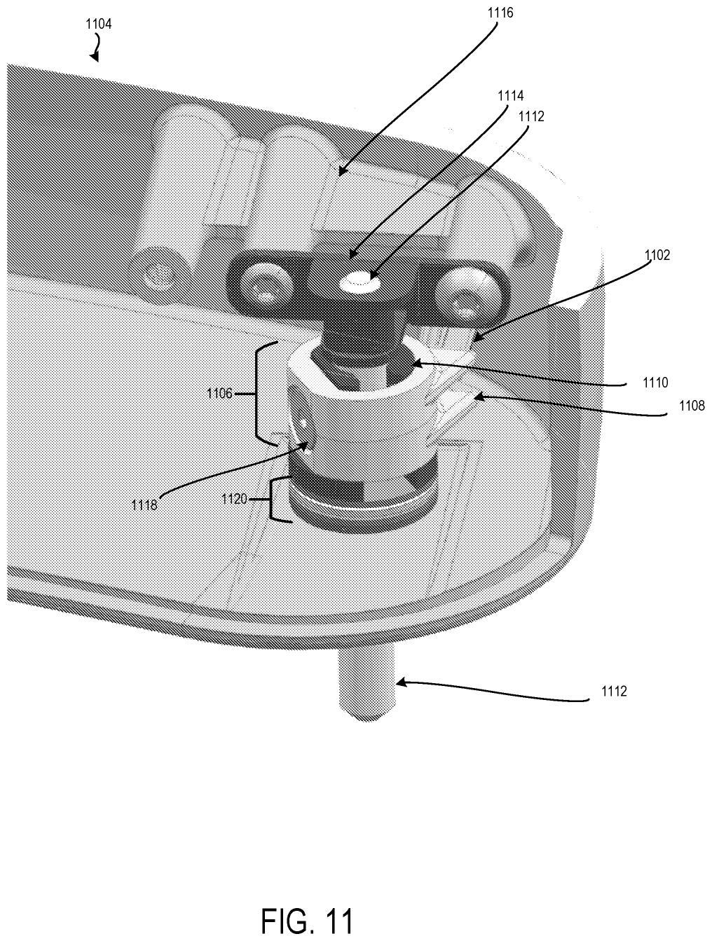

FIG. 11 is a close-up view of interior components of an arm of an electric vehicle charging station cable management structure according to an embodiment. FIG. 11 illustrates a rotation stop element 1102 molded to arm housing 1104 (e.g., of arm 108B) to obstruct a rotation enabling element 1106 from rotating beyond a location of the rotation stop element 1102, or otherwise, to prevent the rotation enabling element 1106 from rotating more than 360 degrees. In an embodiment, the rotation enabling element 1106 can rotate clockwise or counterclockwise within a certain range of degrees until protruding elements 1108 engage with the rotation stop element 1102. In some embodiments, the protruding elements 1108 are made of rubber, or another type of flexible material. In such embodiments, when a large amount of force is applied to rotate the rotation enabling element 1106 beyond the location of the rotation stop element 1102, the protruding elements 1108 can flex to allow additional rotation beyond the rotation stop element 1102 and prevent damage to the rotation stop element 1102 and/or the rotation enabling element 1106.

As illustrated in FIG. 11, the rotation enabling element 1106 includes an axle hat 1110. In an embodiment, the axle hat 1110. In an embodiment, the axle hat 1110 provides a flat base for thrust bearings 1120 positioned below the axle hat 1110 and holds the rotation enabling element 1106 from falling through the arm.

In some embodiments, the interior of the rotation enabling element 1106 is shaped to couple the motion of the axle hat 1110 to the rotation enabling element 1106. In an embodiment, the rotation enabling element 1106 can contain or hold a shaft member 1112 with a first end that extends beyond the arm housing 1104. In an embodiment, the shaft member 1112 can suspend a cable tether holding an electric vehicle charging cable above the ground and allow the cable tether to rotate around a longitudinal axis. In an embodiment, a second end of the shaft member 1112, opposite the first end, can be attached to a mounting element 1114. The shaft member 1112 can be locked onto the rotation enabling element 1106 using a shoulder screw 1118 that passes through the rotation enabling element 1106, the axle hat 1110, and the shaft member 1112. For example, the axle hat 1110 can include a threaded opening to receive and hold the shoulder screw 1118. Once the shoulder screw 1118 is installed, the shaft member 1112 is locked to the rotation enabling element 1106 and the axle hat 1110 to prevent the shaft member 1112 from falling out of the arm housing 1104.

In an embodiment, the mounting element 1114 can be attached to a receiving portion 1116. The receiving portion 1116 can be attached to the arm housing 1104 or can be a molded portion of the arm housing 1104. As illustrated in FIG. 11, the mounting element 1114 can be attached to the receiving portion 1116 using screws.

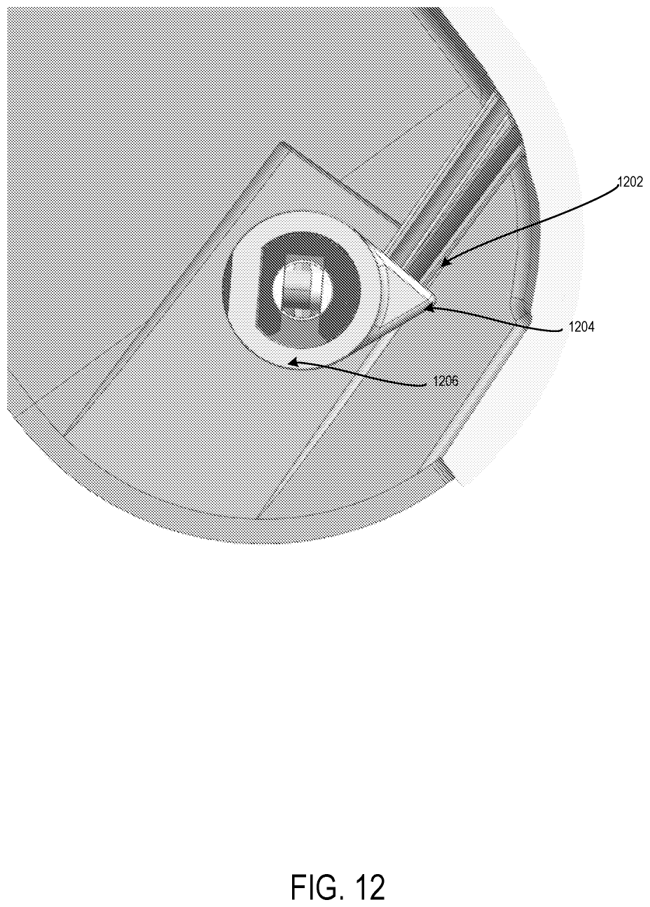

FIG. 12 is an overhead view of a rotation enabling element engaging with a rotation stop element according to an embodiment. FIG. 12 illustrates a different configuration of a rotation stop element 1202 from the rotation stop element 1102 of FIG. 11. In FIG. 12, as the rotation enabling element 1106 is rotated, the protruding elements 1204 are blocked or obstructed by the rotation stop element 1202, to prevent the rotation enabling element 1206 to rotate passed the rotation stop element 1202.

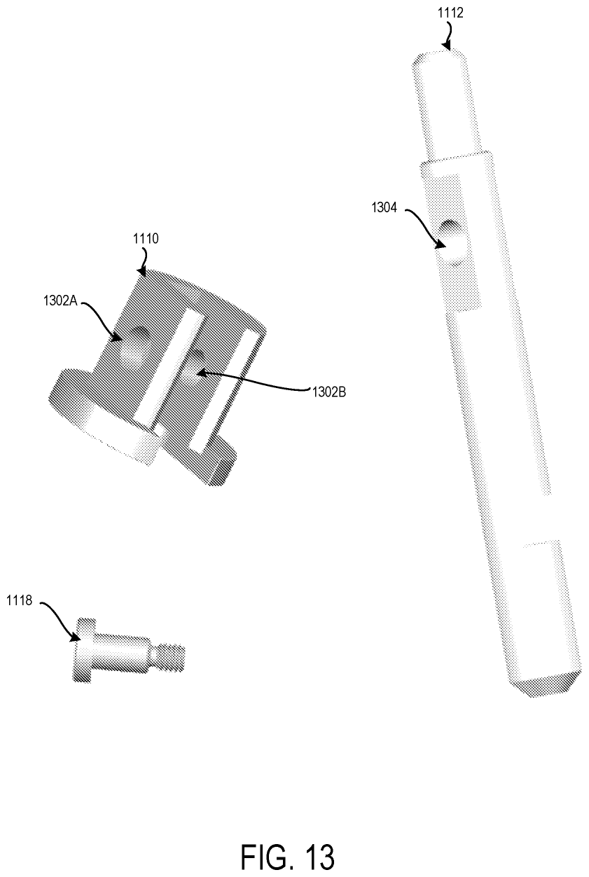

FIG. 13 is a detailed view of an axle hat and a shaft member shown in FIG. 11 according to an embodiment. As illustrated in FIG. 13, axle hat 1110 includes openings 1302A and 1302B that pass through walls of the axle hat 1110. Shaft member 1112 also includes opening 1304 that passes through the shaft member 1112. In an embodiment, the shaft member 1112 can be passed through the space between openings 1302A and 1302B, such that openings 1302A, 1302B, and 1304 are aligned. Once aligned, shoulder screw 1118 can be passed (e.g., screwed) through openings 1302A, 1302B, and 1304 to attach the axle hat 1110 and the shaft member 1112.

In the preceding description, numerous specific details are set forth to provide a more thorough understanding of the present invention. It will be appreciated, however, by one skilled in the art that embodiments can be practiced without such specific details. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

While the invention has been described in terms of several embodiments, those skilled in the art will recognize that the invention is not limited to the embodiments described, can be practiced with modification and alteration within the spirit and scope of the appended claims. The description is thus to be regarded as illustrative rather than limiting.

What is claimed is:

1. A cable management apparatus of an electric vehicle charging station for managing an electric vehicle charging cable comprising:
a housing of the cable management apparatus that houses:
a hub connected to a swing arm housing to allow the swing arm housing to rotate about the hub from a starting position to an ending position,
a damper, wherein a first end of the damper is attached to the housing of the cable management apparatus and a second end of the damper is attached to the swing arm housing to manage retraction of the swing arm housing back to the starting position, and
a first rotation stop element within the housing of the cable management apparatus to prevent the swing arm housing from rotating beyond the ending position; and
the swing arm housing connected to the housing of the cable management apparatus by the hub and the second end of the damper.

2. The cable management apparatus of claim 1, wherein the swing arm housing houses a rotation enabling element.

3. The cable management apparatus of claim 2, wherein the swing arm housing includes a second rotation stop element molded to the swing arm housing to obstruct the rotation enabling element and a shaft member latched to the rotation enabling element from rotating beyond a location of the second rotation stop element.

4. The cable management apparatus of claim 3, wherein the rotation enabling element includes protruding elements that engage with the second rotation stop element, and wherein the protruding elements are configured to flex in response to rotation of the rotation enabling element beyond the second rotation stop element.

5. The cable management apparatus of claim 3, wherein a cable tether latches to the shaft member to suspend the electric vehicle charging cable.

6. The cable management apparatus of claim 1, further comprising:
a mast portion mounted to the electric vehicle charging station and suspending the housing of the cable management apparatus above the electric vehicle charging station.

7. The cable management apparatus of claim 1, wherein the second end of the damper is a piston rod portion, and wherein releasing the swing arm housing from a location other than a starting location causes the damper to dampen the retraction of the swing arm housing back to the starting position.

8. The cable management apparatus of claim 1, wherein the hub includes needle bearings.

9. The cable management apparatus of claim 1, further comprising:
a cable tether that is attached to the swing arm housing, wherein the cable tether includes an opening through which the electric vehicle charging cable passes, and wherein the cable tether suspends the electric vehicle charging cable.

10. The cable management apparatus of claim 1, wherein the ending position is away from the electric vehicle charging station compared to the starting position and extends a reach of the electric vehicle charging cable.

11. An electric vehicle charging station, comprising:
a cable management apparatus to manage an electric vehicle charging cable of the electric vehicle charging station, the cable management apparatus including:
a housing of the cable management apparatus that houses:
a hub connected to a swing arm housing to allow the swing arm housing to rotate about the hub from a starting position to an ending position,
a damper, wherein a first end of the damper is attached to the housing of the cable management apparatus and a second end of the damper is attached to the swing arm housing to manage retraction of the swing arm housing back to the starting position, and
a first rotation stop element within the housing of the cable management apparatus to prevent the swing arm housing from rotating beyond the ending position; and
the swing arm housing connected to the housing of the cable management apparatus by the hub and the second end of the damper.

12. The electric vehicle charging station of claim 11 wherein the swing arm housing houses a rotation enabling element.

13. The electric vehicle charging station of claim 12, wherein the swing arm housing includes a second rotation stop element molded to the swing arm housing to obstruct the rotation enabling element and a shaft member latched to the rotation enabling element from rotating beyond a location of the second rotation stop element.

14. The electric vehicle charging station of claim 13, wherein the rotation enabling element includes protruding elements that engage with the second rotation stop element, and wherein the protruding elements are configured to flex in response to rotation of the rotation enabling element beyond the second rotation stop element.

15. The electric vehicle charging station of claim 13, wherein a cable tether latches to the shaft member to suspend the electric vehicle charging cable.

16. The electric vehicle charging station of claim 11, wherein the cable management apparatus further comprises:
a mast portion mounted to the electric vehicle charging station and suspending the housing of the cable management apparatus above the electric vehicle charging station.

17. The electric vehicle charging station of claim 11, wherein the second end of the damper is a piston rod portion, and wherein releasing the swing arm housing from a location other than a starting location causes the damper to dampen the retraction of the swing arm housing back to the starting position.

18. The electric vehicle charging station of claim 11, wherein the hub includes needle bearings.

19. The electric vehicle charging station of claim 11, further comprising:
a cable tether that is attached to the swing arm housing, wherein the cable tether includes an opening through which the electric vehicle charging cable passes, and wherein the cable tether suspends the electric vehicle charging cable.

20. The electric vehicle charging station of claim 11, wherein the ending position is away from the electric vehicle charging station compared to the starting position and extends a reach of the electric vehicle charging cable.
